(19) United States
(12) Patent Application Publication
(10) Pub. No.: US 2013/0015179 A1
(43) Pub. Date: Jan. 17, 2013

(54) ARC-SHAPED CAVITY OF THE MICROWAVE MOISTURE ANALYZER

(71) Applicant: Nan Du, Shanghai (CN)

(72) Inventor: Nan Du, Shanghai (CN)

(21) Appl. No.: 13/261,378

(22) PCT Filed: May 5, 2011
(86) PCT No.: PCT/CN11/73676

§ 371 Date: Jul. 21, 2012

(30) Foreign Application Priority Data
Jul. 16, 2010 (CN) 201010230740.6

(51) Int. Cl. H05B 6/80

(52) U.S. Cl. 219/756

(57) ABSTRACT

An arc-shaped cavity of a microwave moisture analyzer is classified as an analytical instrument which includes a top panel, a bottom panel and a side panel for forming the cavity, wherein a flat and straight side panel unit provided on the side panel; and a curved side panel unit connected to the flat and straight side panel unit such that the arc-shaped cavity is formed. The flat and straight side panel unit has a straight surface and the curved side panel unit has an arc surface. Through the combined application of focused microwave energy at the radial/axial directions and the reflection/diffusion of the straight surface, the location at which the sample is placed forms a uniform and high field density area which greatly increase the heating efficiency of microwave, and is particularly suitable for sheet-like sample or sample with large surface area. Accordingly, the moisture volatile of the sample can be analysis accurately and efficiently, where the deviation due to too high or too low moisture content in the sample is minimized and the work efficiency for the entire analysis process is increased dramatically. The present invention can be widely used in testing/analysis of moisture content.

### BACKGROUND OF THE PRESENT INVENTION

1. Field of Invention

The present invention relates to an analytical instrument, and more particularly to a heating apparatus for fast removal of moisture content from a testing sample.

2. Description of Related Arts

In accordance with the advance development in scientific research and production technology, quantitative analysis of moisture content (or moisture volatiles) in testing sample becomes the basic testing item in material physical and chemical analysis and one of the important indicators of quality control in different kinds of testing substances.

Based on the different moisture content in different samples, different requirements of moisture analysis are needed.

At present, the analytical method for moisture volatiles in samples includes the conventional oven heating method, the infrared heating method, Karl Fischer titration and Coulometry.

In today's practical application, moisture analysis of samples is mainly used in two areas. In the first situation, particular types of commercial goods and end products for sell in the market are required to fulfill the moisture volatile standard of a particular country and therefore are sent for moisture analysis in order to determine the moisture content of the commercial goods and end products. In the second situation, manufacturers in some industries need to strictly control the moisture target of their products during production in their production lines so as to improve the quality control of the products. Therefore an analytical method for the production line to speedily analyze the moisture content is required. In other words, through providing on-line measuring, the level of moisture volatiles is determined.

In the first situation, since the standard is a standard required by a country, the analytical method for testing moisture volatiles is also limited by the country requirements. Usually, it is required to use the oven heating method and/or the Karl Fischer titration method. These two methods provide relatively high accuracy but require a long time period of analysis (oven heating method requires about 4 hours in average and the time for Karl Fischer titration depends on the moisture content and longer time is required for sample with higher moisture content) and a high skill level of skilled operator (the sample is required to be pre-treated, every step for the analysis process must be treated very carefully and does not accept any mistake).

If the method used in the first situation is directly applied to be used in the second situation on the production line to provide moisture analysis during production, then the time required for analysis is very long while the skilled labor requirement is very high. Therefore, both the labor cost and the production cost will be very high and cannot satisfy the object of fast quality control and adjustment of products during the manufacturing process.

Nowadays, microwave moisture analyzers are usually applied in the second situation, that is to say, microwave moisture analyzers are usually used in the production line. Because of the characteristics of the microwave heating principle, the drawbacks of long time requirement and high standard of skilled labor requirement in oven heating method or Karl Fischer titration method can be solved satisfactorily.

At the same time, when moisture volatiles of samples are analyzed by microwave moisture analyzers, the time required for analysis is usually in a few minutes while it is not required to pre-treat the samples, therefore the use of microwave moisture analyzers is perfectly fitted for the use in the production line which requires fast and simple analytical method.

Also, the ability of microwave in penetrating the sample can ensure that the moisture content in the sample is completely evaporated, thereby the accuracy of analysis can be ensured.

Infrared heating method is another comparable fast analytical method for moisture volatiles. Infrared is an “outside to inside” heating method while microwave is an “inside to outside” heating method. The selective differences between high and low moisture content of testing samples for fast microwave moisture analyzer are small and therefore the effect of level of moisture content of a particular testing sample on the analysis results is small, while infrared analytical method or Karl Fischer titration method has obvious and significant problem in accuracy which is affected by the moisture content level of the sample, a higher accuracy level for sample with lower moisture content and a lower accuracy level for sample with higher moisture content.

Accordingly, microwave moisture analyzer is designed for providing moisture analysis to fit the application in production line of manufacturer, which can satisfactorily providing a fast, simple and accurate analytical method while avoiding the shortcomings of other methods. Therefore, it can be used widely in the production lines of food, chemical engineering, pharmaceutical and agricultural industries.

At present, some manufacturers in China have started to manufacture microwave moisture analyzer. However, the heating cavity which is used to contain sample for microwave heating only employs a rectangular construction which is converted and modified from regular domestic microwave oven. In other words, the rectangular construction is not specifically designed to fit the microwave heating principle and therefore has disadvantages of uneven microwave field, low heating efficiency, high power consumption and long time requirement.

On the other hand, the cavity which is used in other countries usually has a regular octagon cross-section or a circular cross-section (hereafter called octagon cavity and circular cavity respectively).

Through extensive modeling analysis and sample analysis, octagon cavity achieves a very even distribution of microwave but the focused microwave energy effect is not obvious, therefore the treatment time is long and efficiency is low.

Circular cavity has obvious high focused microwave energy effect at one point, which is the center, however the distribution of microwave is uneven and partial or localized burning of samples during analysis may be resulted, therefore adversely affecting the accuracy of the results and the repeatability of the analysis data. Also, since the focused microwave energy is concentrated at one point, a sample in sheet-like form cannot be heated uniformly, and the deviation in the results for samples with high moisture content (eg. 90% or above) or low moisture content (eg. 8% or below) is great, which is poor to the analysis and is not suitable for use with moisture analysis for sample with large surface area or sample in sheet-like form.

### SUMMARY OF THE PRESENT INVENTION

An object of the present invention is to provide an arc-shaped cavity for a microwave moisture analyzer which provides a curved-straight side face design so as to allow microwave to be uniform, focused and distributed inside the cavity or inside a particular area of the cavity, thereby a uniform and high field density of microwave is provided to a proximal area of a sample such that the sample is uniformly heated and moisture can be removed quickly. Accordingly, this design is particularly suitable for use with sheet-like structure sample or sample with large surface area, and can effectively decrease the deviation resulted from the level of moisture content in the sample. Thus, the work efficiency of the entire process of moisture analysis is greatly increased.

Additional advantages and features of the invention will become apparent from the description which follows, and may be realized by means of the instrumentalities and combinations particular point out in the appended claims.

In order to accomplish the object mentioned above, the present invention provides an Arc-shaped cavity for a microwave moisture analyzer which includes a top panel, a bottom panel and a side panel, characterized in that: a flat and straight side panel unit is provided on the side panel; and a curved side panel unit connected to the flat and straight side panel unit such that the arc-shaped cavity is formed.

Preferably, the flat and straight side panel unit has a straight surface and the curved side panel unit has an arc surface.

Accordingly to the preferred embodiment of the present invention, the present invention also provides an arc-shaped cavity of a microwave moisture analyzer which includes a cavity body, wherein a cross-sectional area of the cavity body is an enclosed area formed by a straight-line section and a curved section.

Preferably, the curved section has a portion of an arc segment, a hyperbolic segment or a parabolic segment.

Accordingly to the preferred embodiment of the present invention, the present invention further provide an arc-shaped cavity of a microwave moisture analyzer which includes a cavity body having a plurality of panels for forming the cavity body, wherein the cavity body is formed by at least four panels.

In particular, one of the panels is a side panel having a curved surface.

Preferably, the curved surface is an arc-shaped curved surface, a drum-shaped curved surface or a round shaped curved surface.

Preferably, the flat and straight side panel unit provided on the side panel, the straight-line section or one of the panels excluding the side panel having curved surface has a feed-in opening for microwave output such that a microwave generator is capable of providing microwave inside the arc-shaped cavity through the feed-in opening.

Compared to conventional technology, the present invention has the following advantages:

1. A curved and a straight surface are employed for the construction of the cavity in which the curved surface increases the focused microwave energy ability and the straight surface enhances the uniformity in distribution of microwave inside the cavity. The curved-straight design can facilitate a microwave heating area for placement of a sample and provide a uniform and strong field density of microwave, thereby increasing the heating efficiency of the microwave and suitable for sheet-like sample or sample with large surface area. In addition, deviation of analysis resulting from the moisture content level of the sample is helpfully reduced.

2. A curved and straight design for the cavity of the microwave moisture analyzer in which a feed-in opening is provided on the straight surface of the cavity which can facilitate the manufacture and processing of the feed-in opening, simplify the manufacturing process and requirement, reduce the cost of manufacture and material, and promote the use of microwave moisture analyzer.

3. The entire sample can be heated uniformly, therefore moisture volatiles of the sample can be evaporated easily and the moisture content of the sample can be accurately and effectively determined.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic illustration of an arc-shaped cavity of a microwave moisture analyzer according to a preferred embodiment of the present invention.

FIG. 2 is a cross-sectional illustration of an arc-shaped cavity of a microwave moisture analyzer according to the above preferred embodiment of the present invention.

FIG. 3 is a schematic illustration of an arc-shaped cavity of a microwave moisture analyzer according to another embodiment of the above preferred embodiment of the present invention.

FIG. 4 is a schematic illustration of field density in a modeling for a regular octagonal cavity.

FIG. 5 is another schematic illustration of a modeling for a circular cavity.

FIG. 6 is another schematic illustration of a modeling for an arc-shaped cavity.

FIG. 7 is a schematic diagram illustrating a sample which is placed in the octagonal cavity of a moisture analyzer for testing.

FIG. 8 is a schematic diagram illustrating a sample which is placed in the circular cavity of a moisture analyzer for testing.

FIG. 9 is a schematic diagram illustrating a sample which is placed in the arc-shaped cavity of a moisture analyzer for testing.

### DETAILED DESCRIPTION OF THE PREFERRED EMBODIMENT

The present invention is further described with the accompanying drawings as follows:

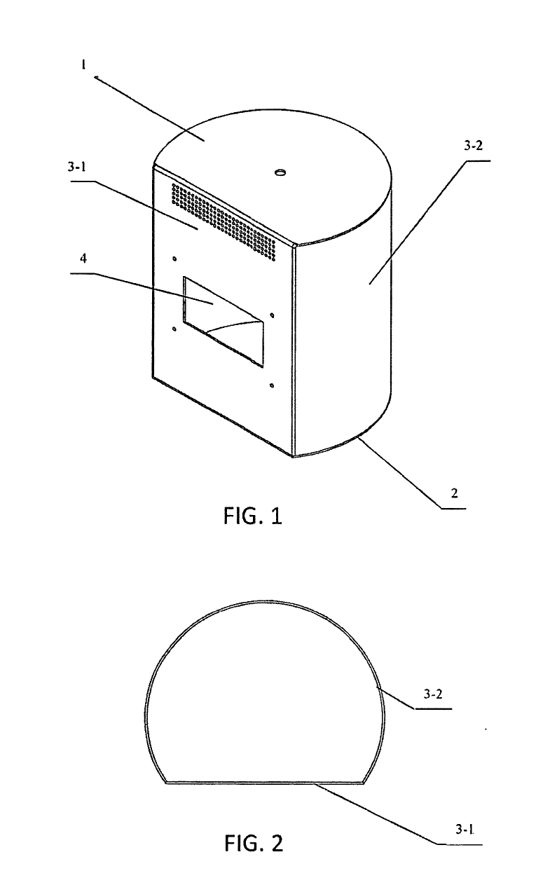

Referring to FIG. 1 of the drawings, an arc-shaped cavity according to the preferred embodiments of the present invention is defined between a top panel 1, a bottom panel 2 and a side panel 3, wherein the cavity is characterized in that the side panel is constructed by a section of flat and straight side panel unit 3-1 and a section of curved side panel unit 3-2 connected to the flat and straight side panel unit 3-1.

Preferably, the curved side panel unit 3-2 has a curved side surface.

In particular, the curved side surface is an arc surface.

In the flat and straight side panel unit, a feed-in opening 4 for microwave output is provided such that microwave generator can provide microwave inside the arc-shaped cavity through the feed-in opening.

The above embodiment employs a curved-straight side panel design in the formation of the cavity which can facilitate placement of sample inside the cavity and formation of a microwave heating area which provides a uniform and high field density of microwave, therefore particularly suitable for sheet-like sample or sample with large surface area while decreasing deviation of analysis resulting from sample with too high or too low moisture content level. Also, the feed-in opening is provided on the straight surface of the cavity which can simplify the manufacturing process and requirement and reduce the cost of manufacture and material. In addition, the curved-straight side panel design of the cavity can facilitate the heating process for sheet-like sample (such as test strips and filter paper) or bulky sample such that the sample can be heated uniformly, therefore moisture volatiles of the sample can be evaporated easily and the moisture content of the sample can be accurately and effectively determined. Moreover, the repeatability and reproducibility of the analysis results are greatly increased.

Referring to FIG. 2 of the drawings, an arc-shaped cavity according to the preferred embodiments of the present invention is defined in a cavity body which is characterized in that a cross-sectional area (at the radial direction) of the cavity body is an enclosed area construction formed by a straight-line section 3-1 and a curved section 3-2.

The curved section is an arc section.

From this figure, the curved-straight design for the side panel and its side face defining the cavity is depicted clearly.

It is worth mentioning that the curved section can either be an arc section or a part of an arc section.

Other features are the same as the description for FIG. 1 of the drawings.

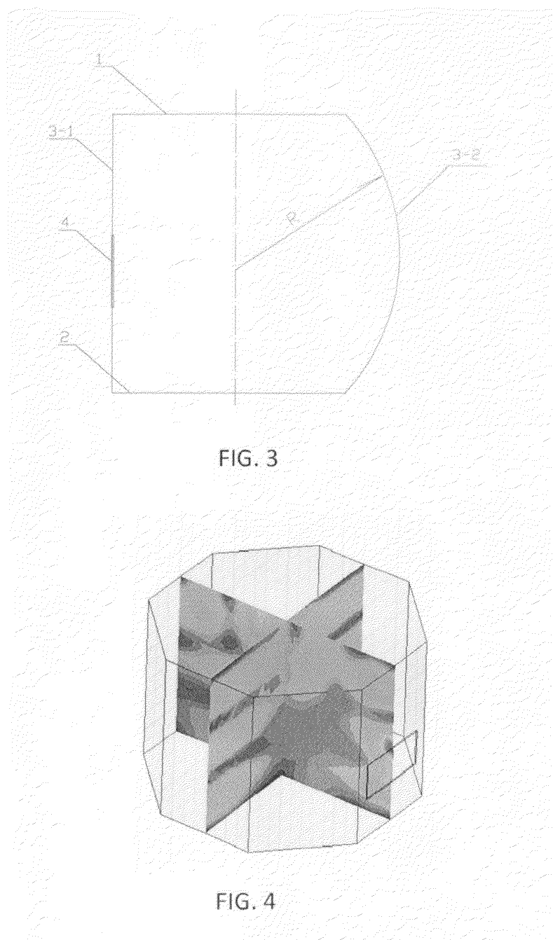

Referring to FIG. 3 of the drawings, the arc-shaped cavity of a microwave moisture analyzer from another perspective according to the preferred embodiment of the present invention is defined in a cavity body which is formed by a plurality of panels and the number of panels is at least four (the panel is referred as pane or side panel in the following description), wherein each side panel has a side face and at least one of the side panel has a curved side surface.

For example, as shown in FIG. 1 of the drawings, the cavity is defined by four panels, which are 1, 2, 3-1 and 3-2, wherein one of the panels is a horizontal curved panel 3-2 having a curved face (which is provided along the radial direction of the cavity), wherein the curved face 3-2 is an arc surface.

Furthermore, as an another exemplary embodiment, based on the curved panel 3-2 is provided at the radial direction, the cavity at the longitudinal direction (axial direction) can also include a circular surface, an arc surface, a drum-shaped surface or a round-shaped surface.

This figure illustrates an arc surface at the axial direction. As shown in this figure, the side panel 3-2 has an arc surface having a radius R.

The curved section, or the arc surface, can be an arc segment, a hyperbolic segment or a portion of a parabolic segment.

Broadly speaking, the curved surface includes any curved surface of any shape and any portion of curved surface for providing focused microwave energy or focused microwave energy towards the center.

This feature is employed for providing microwave focused microwave energy at the curved surface at the axial direction (hereafter refer to as longitudinal focused microwave energy) on top of the center focused microwave energy at the radial direction (hereafter refer to as transverse focused microwave energy).

Other features are the same as the description for FIGS. 1 and 2 of the drawings.

FIG. 4 of the drawings illustrates the microwave field density distribution inside a octagonal cavity by using the software HFSS (High Frequency Structure Simulator) developed by Ansoft company, wherein dark color represents a high level and pale color represents a low level.

The software is standard software used in the industry and therefore the method of generation of figure, the setting parameters and the method of results presentation are not further described. Details about the software can be found in the relevant chapter in the following reference: <<HFSS Illustratoin>> (Author: Li Min Yang, Publisher: People's publisher, 2010-05).

As illustrated in the figure, because all sides of the octagonal cavity are straight panel and have reflection effect on microwave, there is no obvious and particular area with over-concentrated field density and the field density is relatively uniform at the center of the cavity, which is also the area for placing sample.

However, since all the eight sides are straight surface and has reflection and diffusion on microwave, thus there is no focused microwave energy effect at the center of the cavity and hence the time required for heating is relatively long and the heating efficiency is relatively low.

In other words, as shown in the figure, octagonal cavity provides uniform field density but fails to provide focused microwave energy.

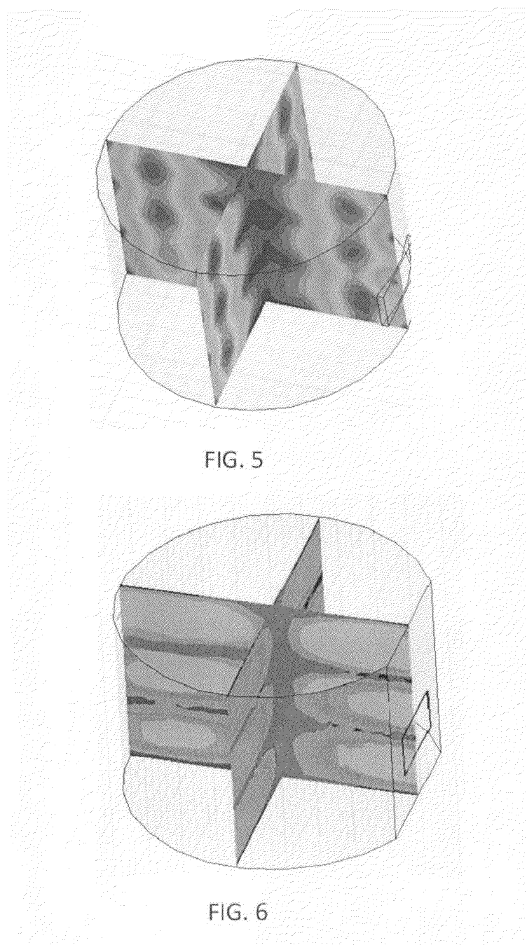

FIG. 5 illustrates the field density distribution of a circular cavity by using the HFSS software in which dark area represents a high level of field density while a light color represents a low level of field density.

Since all the side panels provide round and curved surface, a horizontal focused microwave energy towards the center is provided and therefore the field density is over-concentrated at the center of the cavity. The cross-sectional area with high field density is smaller than the area of the sample, causing a hot spot at the center portion of the sample and burnt point at the center of the sample during heating process, and therefore deviation and inaccurate analysis are resulted.

As shown in this figure, the focused microwave energy at the center is significant but the distribution is not uniform and hot spot is noticed in the circular cavity.

Referring to FIG. 6 of the drawings, the field density distribution of an arc-shaped cavity by using the HFSS software is illustrated in which dark area represents a high level of field density while a light color represents a low level of field density.

Because the side panels include an arc surface and a straight surface in which the arc surface can increase focused microwave energy such that focused microwave energy is provided at the center of the cavity which is also the area for placing sample and the straight surface can have reflection/diffusion effect on the microwave such that an uniformly distributed microwave is provided at the center of the cavity which is also the area for placing sample, the sample can be heated quickly without burnt point during the heating process.

As shown in the figure, the arc-shaped cavity provides significant focused microwave energy while the distribution of microwave is relatively uniform.

Experimental Data:

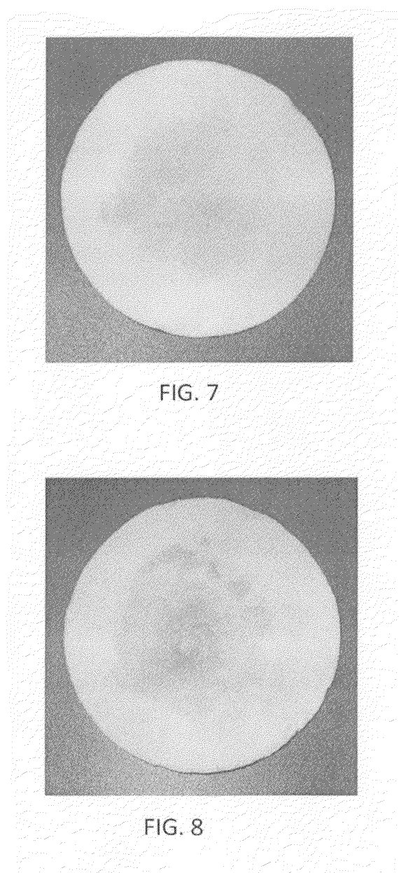

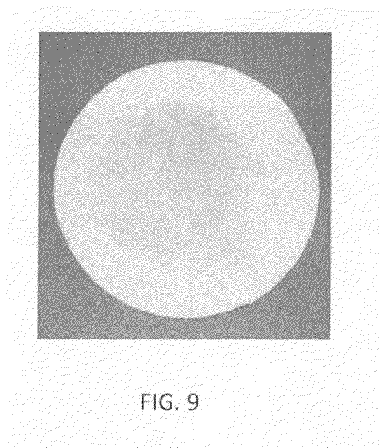

Spread honey solution with 22% water onto a glass fiber and conduct moisture analysis by using three moisture analyzers with the above three-mentioned different cavity structure (octagonal, circular and arc-shaped cavities). The results and the appearance of the sample are shown as follows:

| | Cavity | | |
|---|---|---|---|
| | [symbol] | | |
| | Octagonal | Circular | Arc |
| Moisture | 21.76% | 23.28% | 21.89% |
| analysis | | | |
| Heating | 4 min 15 second | 2 min 46 second | 2 min 23 second |
| Sample | As shown in | As shown in | As shown in |
| | FIG. 7 | FIG. 8 | FIG. 9 |
| Explanation | Based on the | Based on the | Based on the |
| | appearance, the | appearance, burnt | appearance, the |
| | sample does not | points are noticed | sample is uniformly |
| | have burnt point | in the sample, | heated, the heating |
| | but the heating | overheating is | time is the shortest, |
| | time is relatively | occurred and | the results from |
| | long. | the deviation for | moisture analysis |
| | | results from | is the closest to |
| | | moisture analysis | the actual value. |
| | | is relatively great. | |

[symbol]

indicates data missing or illegible when filed

Experimental Data/Results Analysis:

1. Octagonal-Shaped Cavity:

Referring to the sample appearance in FIG. 7 and the results, the visual inspection of the sample does not show any evidential burnt point which illustrated that the heating area of the cavity has relatively uniform microwave field density, and the value of moisture content from the moisture analysis, compared to the actual value, is relatively accurate. However, the time required is relative long, which illustrated that the strength of microwave in the heating area of sample is relatively weak in the octagonal-shaped cavity.

2. Circular-Shaped Cavity:

Referring to the sample appearance in FIG. 8 and the results, the visual inspection of the sample indicates burnt point area (the dark are at the center) which illustrated that the heating area of the cavity does not provide uniform microwave field density, and the microwave focused microwave energy at a particular localized area is too strong, causing overheating of the sample in the heating area. The value of moisture content from the moisture analysis, compared to the actual value, shows relatively great deviation.

3. Arc-Shaped Cavity:

Referring to the sample appearance in FIG. 9 and the results, the visual inspection of the sample does not show any evidential burnt point which illustrated that the heating area of the cavity has relatively uniform microwave field density. The time required for heating is the shortest amongst the three, illustrating that the microwave focused microwave energy at localized area is relatively strong. The value of moisture content from the moisture analysis, compared to the actual value, is relatively close to the actual value.

Based on the above analysis, it is shown that the results of the above experiment are consistent to and corresponding to the illustrations as shown in FIGS. 4-6 of the drawings.

The reasoning for the arc-shaped cavity which can provide significant focused microwave energy and uniform microwave field density distribution:

The arc-shaped cavity according to the preferred embodiments of the present invention includes a top panel, a bottom panel and a side panel, wherein the cavity is characterized in that the side panel is constructed by a section of flat and straight side panel unit and a section of curved side panel unit connected to the flat and straight side panel unit.

The curved side panel unit provides a curved surface which provides focused microwave energy effect of microwave, thereby providing focused microwave energy effect to the center area of the cavity, which is the area of placing the sample. The straight side panel provides a straight surface which provides reflection/diffusion effect to microwave, thereby providing a uniform distribution of microwave at the center area of the cavity, which is also the area of placing the sample.

The arc-shaped cavity construction according to the preferred embodiment of the present invention is employed to eliminate the problems of insignificant focused microwave energy effect and long heating time caused by an octagonal-shaped cavity, and to eliminate the problems of excessive focused microwave energy effect and occurrence of hot spot caused by a circular-shaped cavity.

The arc-shaped cavity construction according to the preferred embodiment of the present invention allows a fast heating time without burnt point during the heating process. Because the microwave focused microwave energy effect is provided to a defined area which is the area of heating the entire sample, thereby the cavity of the present invention is suitable for use with sheet-like sample or sample having a large surface area and is effective in decreasing deviation of results caused by sample having an excessively high or low moisture content.

Also, the arc-shaped cavity construction according to the preferred embodiment of the present invention has a curved surface and a straight surface which is capable of directing the focused microwave energy effect towards area around the sample for providing heating effect through reflection, thereby increasing the heating efficiency of the microwave while the field density is uniformly distributed. Accordingly, the sample will be heated uniformly through which the rate of evaporation of the moisture content in the sample can be increased and the time required for treating/analysis is shortened. As a result, the workload as well as the overall cost of analysis is decreased and the work efficiency is increased dramatically.

In addition, through having a curved surface and a straight surface for the arc-shaped cavity according to the preferred embodiment of the present invention, the feed-in opening can be provided on the straight side panel which has a straight surface, thereby facilitating the manufacture or processing of the feed-in opening, simplifying the manufacturing process and requirement and effectively reducing the cost of manufacture and material. Accordingly, it is more easier to be accepted by the user and therefore subject to be promoted and applied in the industry.

In particular, microwave or the microwave refers to electromagnetic wave having a range of 300 MHz ˜300 Hz.

Microwave has three basic properties, which are penetration, reflection and absorption ability.

The ITU Radiocommunication Sector has standard provisions for frequency regulation. The ranges for industrial, scientific and medical use are 433 MHz, 915 MHz, 2450 MHz, 5800 MHz, and 22125 MHz respectively. The work frequency of microwave heating device used for moisture content analysis is microwave of 2450 MHz in general.

Microwave oven is actually an oscillator which generates microwave in which the microwave has a wavelength of 122 mm and a frequency of 2450 MHz.

Microwave oven (or the oven) is an enclosed cavity within which microwave energy is converted to heat energy for heating testing sample or sample for heating, which is a microwave oscillating cavity.

Based on the range of wavelength employed in the microwave heating device, a microwave heating device has the dimension of same order of magnitude as a conventional microwave device.

Accordingly, changes and modifications of shape of the cavity at mm or cm level will directly affect the transmission/distribution/reflection/focused microwave energy effect of microwave in the cavity. In other words, any changes of the cavity at a mm or cm scale will affect important indicators such as the distribution uniformity, the focused microwave energy effect and the field density inside the cavity, and therefore will have a dramatic effect thereon.

In addition, according to the general knowledge in physics, the value of power of absorption of microwave by a medium P is directly proportional to frequency f, and to square of electric field strength E, the relative permittivity ∈r and dielectric loss tangent tgδ.

That is: P=2πf·E²·∈r·V·tgδ

The change in microwave field density inside the cavity will directly affect the drying rate (the heating time) of the heating sample and the time of the heating sample to have a particular required moisture content.

Therefore, the field density distribution of microwave inside the cavity will have a direct effect on the rate of heating or drying and work efficiency of analysis of the moisture analyzer.

Accordingly, any changes or modifications of the shape or structure of the cavity of the microwave heating device will impose important determinant effect on the microwave heating efficiency uniformity of field density inside the cavity, the uniformity of heating of the sample, the decrease in analysis time in relation to treating/testing sample, the decrease in workload on treating/testing the sample and the overall cost of analysis, and the increase in the work efficiency of the analysis.

When it is clear in the direction and approach for the present invention, through determining a reasonable ratio of the curved and the straight surface (can be in terms of area or size), the microwave focused microwave energy (field density) requirement is met; and through microwave reflection/diffusion to ensure the uniformity of field density inside the area or cavity at which the sample is placed, to achieve the and technical result of the present invention.

### INDUSTRIAL UTILITY

The technical solution provided by the present invention makes use of the “straight line travel and reflection by metallic material” properties of microwave, and employs the above described method which involves “longitudinal”/“transverse” focused microwave energy effect together with plane reflection/diffusion properties of microwave to create a defined heating area which has a uniform and sufficient high level of field density at which the sample is placed, thereby increasing the heating efficiency of microwave and is particularly suitable for use with sheet-like sample or sample with large surface area, effectively decreasing the deviation of analysis for the sample and dramatically increasing the work efficiency of the entire moisture analyzing process.

The present invention is applied in the microwave moisture analyzer and meets the requirements of “fast, simple, accurate” analysis in the production line, therefore facilitating manufactures or corporations in different industries such as the food industry, the chemical engineering industry, the pharmaceutical industry and the agricultural industry to utilize the minimum amount of time to effectively control the quality of their products and to bring in the maximum level of economic benefits.

It is worth mentioning that the present invention can be widely used in moisture analysis for different kinds of samples.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1: An Arc-shaped cavity of a microwave moisture analyzer which includes a top panel, a bottom panel and a side panel, comprising:
a flat and straight side panel unit provided on the side panel; and
a curved side panel unit connected to said flat and straight side panel unit such that said arc-shaped cavity is formed.

2. The arc-shaped cavity of the microwave moisture analyzer, as recited in claim 1, wherein said flat and straight side panel unit has a straight surface and said curved side panel unit has an arc surface.

3. An Arc-shaped cavity of a microwave moisture analyzer which includes a cavity body, wherein a cross-sectional area of said cavity body is an enclosed area formed by a straight-line section and a curved section.

4. The arc-shaped cavity of the microwave moisture analyzer, as recited in claim 3, wherein said curved section has an arc segment, a hyperbolic segment or a portion of a parabolic segment.

5. An Arc-shaped cavity of a microwave moisture analyzer which includes a cavity body having a plurality of panels for forming said cavity body, wherein said cavity body is formed by at least four panels.

6. The arc-shaped cavity of the microwave moisture analyzer, as recited in claim 5, wherein one of said panels is a side panel having a curved surface.

7. The arc-shaped cavity of the microwave moisture analyzer, as recited in claim 5, wherein at least one of said panel is a side panel having a curved surface.

8. The arc-shaped cavity of the microwave moisture analyzer, as recited in claim 6, wherein at least one of said panel is a side panel having a curved surface.

9. The arc-shaped cavity of the microwave moisture analyzer, as recited in claim 6, wherein said curved surface is an arc-shaped curved surface, a drum-shaped curved surface or a round shaped curved surface.

10. The arc-shaped cavity of the microwave moisture analyzer, as recited in claim 1, wherein said flat and straight side panel unit provided on the side panel, said straight-line section or one of said panels excluding said side panel having curved surface has a feed-in opening for microwave output such that a microwave generator is capable of providing microwave inside the arc-shaped cavity through the feed-in opening.

11. The arc-shaped cavity of the microwave moisture analyzer, as recited in claim 7, wherein said curved surface is an arc-shaped curved surface, a drum-shaped curved surface or a round shaped curved surface.

12. The arc-shaped cavity of the microwave moisture analyzer, as recited in claim 3, wherein said flat and straight side panel unit provided on the side panel, said straight-line section or one of said panels excluding said side panel having curved surface has a feed-in opening for microwave output such that a microwave generator is capable of providing microwave inside the arc-shaped cavity through the feed-in opening.

13. The arc-shaped cavity of the microwave moisture analyzer, as recited in claim 7, wherein said flat and straight side panel unit provided on the side panel, said straight-line section or one of said panels excluding said side panel having curved surface has a feed-in opening for microwave output such that a microwave generator is capable of providing microwave inside the arc-shaped cavity through the feed-in opening.
